(19) United States
(12) Patent Application Publication
(10) Pub. No.: US 2026/0276413 A1
(43) Pub. Date: Sep. 17, 2026

(54) BRILLOUIN GAIN ANALYZER AND BRILLOUIN GAIN ANALYSIS METHOD

(71) Applicant: NIPPON TELEGRAPH AND TELEPHONE CORPORATION, Tokyo (JP)

(72) Inventors: Takahiro ISHIMARU, Musashino-shi, Tokyo (JP); Hiroshi TAKAHASHI, Musashino-shi, Tokyo (JP); Yoshifumi WAKISAKA, Musashino-shi, Tokyo (JP); Daisuke IIDA, Musashino-shi, Tokyo (JP); Yusuke KOSHIKIYA, Musashino-shi, Tokyo (JP)

(73) Assignee: NIPPON TELEGRAPH AND TELEPHONE CORPORATION, Tokyo (JP)

(21) Appl. No.: 18/877,141

(22) PCT Filed: Jun. 23, 2022
(86) PCT No.: PCT/JP2022/025165

§ 371 Date: Dec. 19, 2024

(51) Int. Cl. G01D 5/353; G01L 1/24

(52) U.S. Cl. CPC G01D 5/35364; G01D 5/35335; G01L 1/242

(57) ABSTRACT

An object of the present invention is to provide a Brillouin gain analysis device and a Brillouin gain analysis method capable of measuring a high-speed strain change of an optical fiber in a distributed manner.

According to the present invention, a Brillouin gain analysis device 301 includes a laser 11 that outputs continuous light having a single frequency, a pulse generator 12 that pulses the continuous light from the laser and enters the pulsed light into one end of an optical fiber 50 to be measured, an ASE light source 13 that generates continuous light having a frequency component broader than the frequency of the continuous light output from the laser 11 and enters the generated continuous light into another end of the optical fiber 50, a modulator 14 that generates local light obtained by shifting the frequency of the continuous light from the laser 11 by any frequency, and a detector 15 that heterodyne-detects Brillouin scattered light generated by the optical fiber and the local light.

### TECHNICAL FIELD

The present disclosure relates to reflection measurement in which sensing is performed by measuring scattered light of light entering into an optical fiber.

### BACKGROUND ART

As an optical fiber sensing technology, there is a measurement technique called Brillouin optical time domain analysis (BOTDA) as illustrated in FIG. 1. In this method, a Brillouin gain spectrum (BGS) as illustrated in FIG. 2 is acquired in order to measure the strain and temperature of an optical fiber 50. The strain and temperature of the optical fiber can be acquired in a distributed manner by a change 21 in the peak of the BGS. It is necessary to perform a frequency sweep of probe light Lpr in order to ascertain a Brillouin frequency shift (BFS) that is a shift amount of the change 21 in the peak of the BGS. When pump light Lpn that has been pulsed once enters into the optical fiber 50, the frequency of the probe light Lpr is fixed, and thus the frequency of the probe light Lpr needs to be changed, and the pulsed pump light Lpn needs to enter a plurality of times in order to measure the entire BGS.

### CITATION LIST

### Non Patent Literature

Non Patent Literature 1: Hiroshi TAKAHASHI, Chihiro KIDO, Kunihiro TOGE, Tetsuya MANABE, “Brillouin Analysis for Loss Measurement Using Broadband Probe Pulse”, Proceedings of the 2014 Society Conference of the Institute of Electronics, Information and Communication Engineers, B-13-21, 2014

Non Patent Literature 2: Kikuchi, Kazuro. “Fundamentals of coherent optical fiber communications”, Journal of lightwave technology, vol. 34, Issues. 1, pp. 157-179, 2015.

### SUMMARY OF INVENTION

### Technical Problem

In BOTDA, Brillouin scattered light having any frequency as indicated by a broken line 22 in FIG. 2 is acquired in the entire length direction of a fiber in one measurement. In order to obtain optical information at all frequencies in a BGS range, it is necessary to set a sweep range 23 of the frequency of probe light as the BGS range, and it takes time to perform measurement. Therefore, BOTDA has a problem that it is difficult to measure a high-speed strain change of the optical fiber.

In order to measure a high-speed strain change of an optical fiber, for example, Non Patent Literature 1 discloses a measurement method of avoiding a change in a frequency of probe light and entering of pulsed pump light a plurality of times. FIG. 3 is a diagram illustrating BOTDA disclosed in Non Patent Literature 1. A measurement target of the BOTDA disclosed in Non Patent Literature 1 is a network NW from which an optical fiber is branched. A reflecting device Mr that reflects light is installed at a far end (an end surface opposite to an entering end) of the optical fiber after being branched. The BOTDA disclosed in Non Patent Literature 1 has a device configuration that measures a loss of each optical fiber after being branched, from the entering end. The BOTDA disclosed in Non Patent Literature 1 measures BOTDA with probe light reflected by the reflecting device Mr and pump light entering into the probe light with a delayed timing.

The BOTDA in Non Patent Literature 1 uses amplified spontaneous emission (ASE) including a broadband frequency component as the probe light, extracts an intensity of a Brillouin gain independently of variation in Brillouin frequency shift (BFS), and measures the loss of an optical fiber. However, the BOTDA in Non Patent Literature 1 is intended to measure the optical fiber branched in the network NW, and both the pump light and the probe light are pulsed. Thus, it is not possible to measure the distribution of the entire optical fiber. That is, the BOTDA in Non Patent Literature 1 can measure the loss of the optical fiber at a high speed, but has a problem that it is difficult to measure a high-speed strain change of the optical fiber in a distributed manner.

Therefore, in order to solve the above problems, an object of the present invention is to provide a Brillouin gain analysis device and a Brillouin gain analysis method capable of measuring a high-speed strain change of an optical fiber in a distributed manner.

### Solution to Problem

In order to achieve the above object, according to the present invention, in BOTDA, not pulsed light but ASE that is broadband continuous light is used as probe light to acquire Brillouin scattering by optical heterodyne detection.

Specifically, according to the present invention, a Brillouin gain analysis device includes a laser that outputs continuous light having a single frequency, an amplified spontaneous emission (ASE) light source that generates continuous light that has a frequency component broader than a frequency of the continuous light output by the laser and enters the continuous light into one end of an optical fiber to be measured, a pulse generator that pulses the continuous light from the laser and enters the pulsed light into another end of the optical fiber, a modulator that generates local light obtained by shifting the frequency of the continuous light from the laser by any frequency, and a detector that heterodyne-detects Brillouin scattered light generated by the optical fiber and the local light.

Further, according to the present invention, a Brillouin gain analysis method includes entering, as probe light, amplified spontaneous emission (ASE) continuous light having a frequency component broader than a frequency of laser light having a single frequency into one end of an optical fiber to be measured, pulsing the laser light and entering the pulsed light into another end of the optical fiber as pump light, generating local light by shifting the frequency of the laser light by any frequency, and heterodyne-detecting Brillouin scattered light generated in the optical fiber and the local light.

In BOTDA, probe light is broadened and optical heterodyne detection is used, whereby Brillouin scattered light on an optical fiber can be acquired with one pulsed pump light beam in a distributed manner. Therefore, it is not necessary to perform a frequency sweep of the probe light or entering of the pump light a plurality of times.

Thus, the present invention can provide a Brillouin gain analysis device and a Brillouin gain analysis method capable of measuring a high-speed strain change of an optical fiber in a distributed manner.

The Brillouin gain analysis device according to the present invention further includes a signal processing unit that performs Fourier transform on a signal heterodyne-detected by the detector to detect a Brillouin gain spectrum (BGS) and acquire a vibration distribution of the optical fiber from a time-series change in a peak of the BGS.

Further, the Brillouin gain analysis method according to the present invention further includes performing Fourier transform on the heterodyne-detected signal to detect a Brillouin gain spectrum (BGS), and acquiring a vibration distribution of the optical fiber from a time-series change in a peak of the BGS.

The obtained Brillouin scattered light includes a plurality of frequency components. Therefore, the BGS is calculated by performing processing of obtaining a frequency component, such as Fourier transform, by setting a window function on the Brillouin scattered light.

Vibration applied to the optical fiber can be acquired by converting the Brillouin scattered light into a spectrum.

The Brillouin gain analysis device in the present invention can also be implemented by a computer and a program, and the program can be recorded in a recording medium or provided through a network.

The above inventions can be combined in any possible manner.

### Advantageous Effects of Invention

The present invention can provide a Brillouin gain analysis device and a Brillouin gain analysis method capable of measuring a high-speed strain change of an optical fiber in a distributed manner.

### BRIEF DESCRIPTION OF DRAWINGS

FIG. 1 is a diagram illustrating BOTDA.

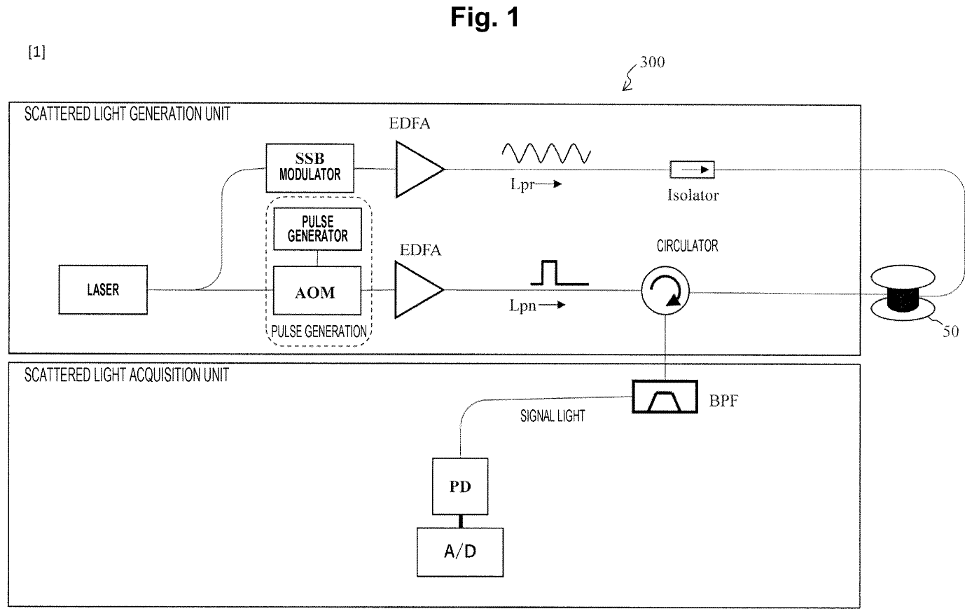

FIG. 2 is a diagram illustrating a measurement principle of the BOTDA.

FIG. 3 is a diagram illustrating an application example of the BOTDA.

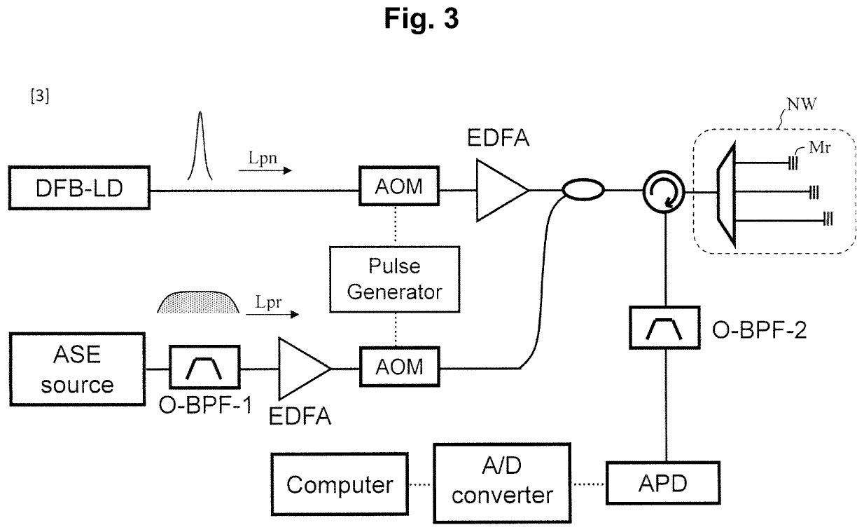

FIG. 4 is a diagram illustrating a Brillouin gain analysis device according to the present invention.

FIG. 5 is a diagram illustrating comparison of probe light.

FIG. 6 is a diagram illustrating a configuration of a detector.

FIG. 7 is a diagram illustrating a measurement principle of the Brillouin gain analysis device according to the present invention.

FIG. 8 is a diagram illustrating a Brillouin gain analysis method according to the present invention.

FIG. 9 is a diagram illustrating an experimental system for acquiring Brillouin scattered light by ASE light.

FIG. 10 is a diagram illustrating an experimental result of acquiring the Brillouin scattered light by the ASE light.

### DESCRIPTION OF EMBODIMENTS

Embodiments of the present invention will be described with reference to the accompanying drawings. The embodiments to be described below are examples of the present invention, and the present invention is not limited to the embodiments to be described below. The same reference signs in the present specification and drawings indicate the same components.

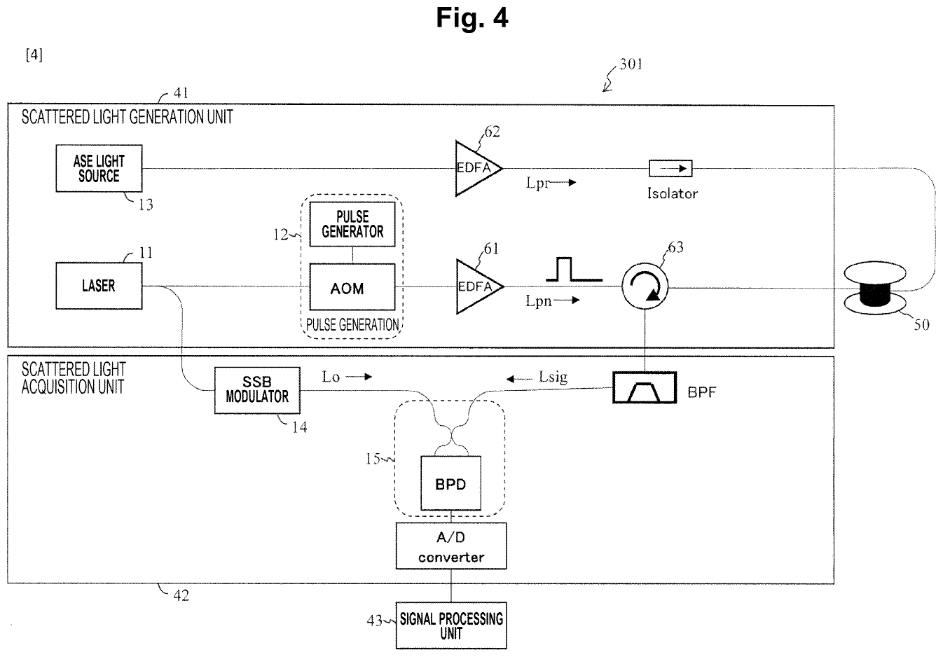

FIG. 4 is a diagram illustrating a Brillouin gain analysis device 301 according to the present embodiment. The Brillouin gain analysis device 301 includes a laser 11 that outputs continuous light having a single frequency, an amplified spontaneous emission (ASE) light source 13 that generates continuous light that has a frequency component broader than a frequency of the continuous light output by the laser 11 and enters the continuous light into one end of an optical fiber 50 to be measured, a pulse generator 12 that pulses the continuous light from the laser 11 and enters the pulsed light into another end of the optical fiber 50, a modulator 14 that generates local light obtained by shifting the frequency of the continuous light from the laser 11 by any frequency, and a detector 15 that heterodyne-detects Brillouin scattered light generated by the optical fiber and the local light.

The Brillouin gain analysis device 301 includes a scattered light generation unit 41 and a scattered light acquisition unit 42.

The scattered light generation unit 41 generates two light beams of pump light Lpn and probe light Lpr, and causes the light beams to oppositely propagate through the optical fiber 50 to be tested.

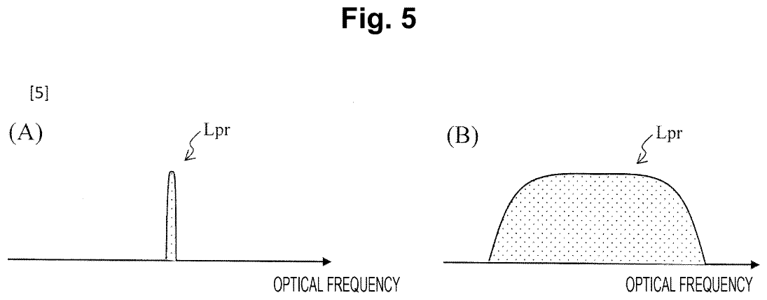

The pump light Lpn is generated in a manner that continuous light that has a single frequency and is output from the laser 11 is pulsed by intensity modulation in an AOM in the pulse generator 12. The power of the pump light Lpn is amplified by an EDFA 61. On the other hand, the probe light Lpr is generated in a manner that broadband light generated by using the ASE light source 13 is amplified by an EDFA 62. FIG. 5 is a diagram in which the probe light Lpr (FIG. 5(A)) of a Brillouin gain analysis device 300 is compared with the probe light Lpr (FIG. 5(B)) of the Brillouin gain analysis device 301.

The pump light Lpn and the probe light Lpr interact with each other in the optical fiber 50 to be tested. With the interaction, light in which Brillouin scattered light by the pump light Lpn is superimposed on the probe light Lpr is transmitted to the scattered light acquisition unit 42 by a circulator 63.

The scattered light acquisition unit 42 converts the light transmitted from the scattered light generation unit 41 into an electric signal. Regarding the light, first, the component of the Rayleigh scattered light is removed by a BPF 64, and signal light Lsig of only Brillouin scattered light is obtained.

Further, continuous light that has a single frequency and is branched from the laser 11 is also transmitted to the scattered light acquisition unit 42. An SSB modulator 14 modulates the continuous light to the vicinity of Brillouin frequency shift (BFS) and outputs the modulated light as local light Lo.

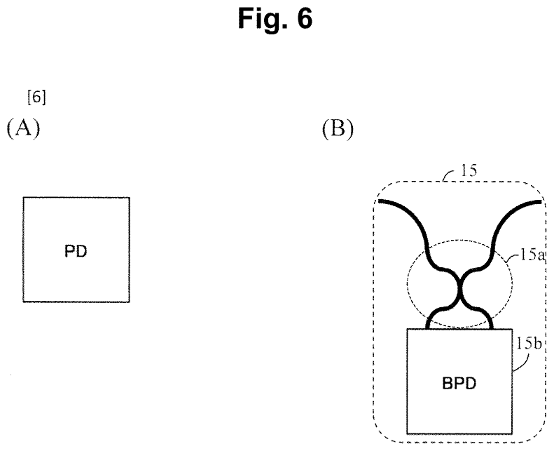

A detector 15 performs heterodyne detection by using the signal light Lsig and the local light Lo. FIG. 6 is a diagram in which a detector (FIG. 6(A)) of the Brillouin gain analysis device 300 and the detector 15 (FIG. 5(B)) of the Brillouin gain analysis device 301 are compared with each other. Although the detector of the Brillouin gain analysis device 300 is a photodiode, the detector 15 of the Brillouin gain analysis device 301 includes a 50:50 coupler 15a and a balanced photodiode (BPD; Balanced Photo Detector) 15b.

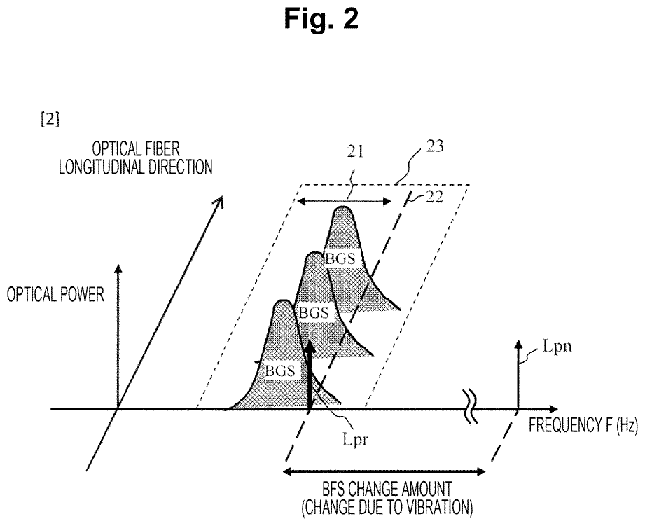

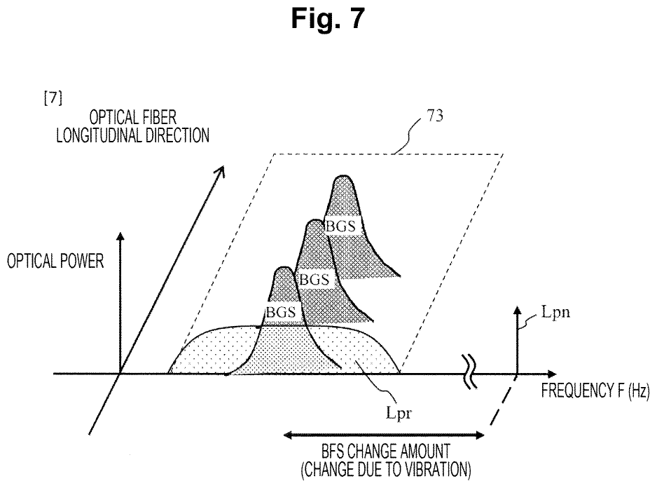

FIG. 7 is a diagram illustrating a measurement principle of the Brillouin gain analysis device 301. As compared with the BOTDA of FIG. 2 in the related art, the probe light Lpr has a broadband and can sufficiently cover a frequency range 23 of the BGS. Therefore, in the BOTDA in the related art, measurement needs to be performed a plurality of times by changing the frequency of the probe light Lpr, but the Brillouin gain analysis device 301 can acquire the BGS with one measurement.

The Brillouin gain analysis device 301 further includes a signal processing unit 43 that performs Fourier transform on a signal heterodyne-detected by the detector 15 to detect the Brillouin gain spectrum (BGS) and acquire a vibration distribution of the optical fiber 50 from a time-series change in a peak of the BGS.

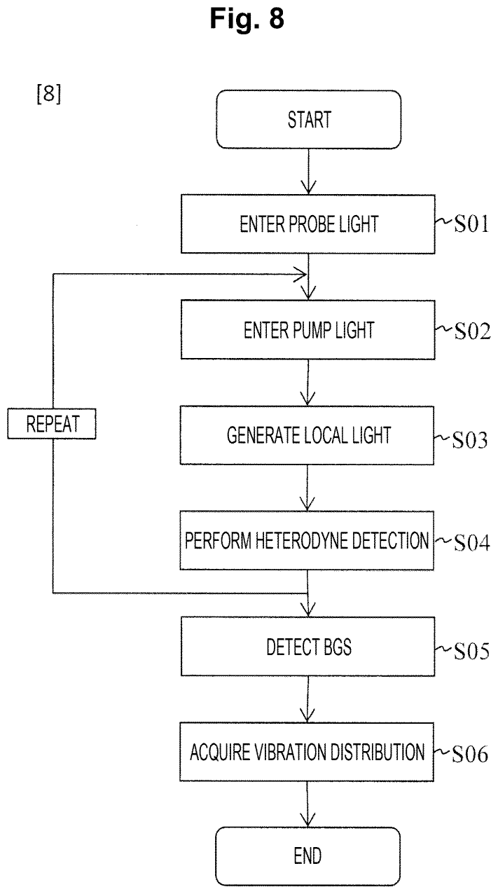

FIG. 8 is a flowchart illustrating the operation of the Brillouin gain analysis device 301 including the signal processing unit 43. The present Brillouin gain analysis method includes entering, as probe light Lpr, amplified spontaneous emission (ASE) continuous light having a frequency component broader than a frequency of laser light having a single frequency into one end of an optical fiber 50 to be measured (Step S01), pulsing the laser light and entering the pulsed light into another end of the optical fiber 50 as pump light Lpn (Step S02), generating local light Lo by shifting the frequency of the laser light by any frequency (Step S03), and heterodyne-detecting Brillouin scattered light Lsig generated in the optical fiber 50 and the local light Lo (Step S04).

In the signal processing unit 43, the Brillouin gain analysis method further includes performing Fourier transform on the heterodyne-detected signal to detect a Brillouin gain spectrum (BGS) (Step S05), and acquiring a vibration distribution of the optical fiber 50 from a time-series change in a peak of the BGS (Step S06).

First, in Step S01, light of the ASE light source 13 in a range considering the BFS of the BGS enters into one end of the optical fiber 50 as the probe light Lpr.

Then, in Step S02, the pump light Lpn having a single frequency enters into the other end of the optical fiber 50, and Brillouin scattered light is generated by causing the probe light Lpr and the pump light Lpn to interact with each other in the optical fiber 50.

In Step S03, the local light Lo having a frequency in the vicinity of the BFS is generated in a manner that the frequency of light branched from the light source of the pump light is shifted by any frequency.

In Step S04, the Brillouin scattered light Lsig and the local light Lo are heterodyne-detected. Thus far, signals necessary for forming the BGS in a distributed manner with one pump light pulse can be received.

Steps S02 to S04 are repeated for the time in which the vibration is desired to be detected.

After the time has elapsed, Fourier transform is performed on the acquired signal to form the BGS in Step S05.

Finally, in Step S06, the vibration is acquired by observing the time-series change in the peak of the BGS.

That is, the pump light is a pulse, and the probe light is continuous light. Once entering of the pump light corresponds to one measurement of the entire optical fiber 50. Then, the pump light of this pulse enters for a time in which measurement is desired to be performed, and vibration measurement is performed.

### EXAMPLES

In the present example, an experimental result of acquiring the Brillouin scattered light by ASE light will be described.

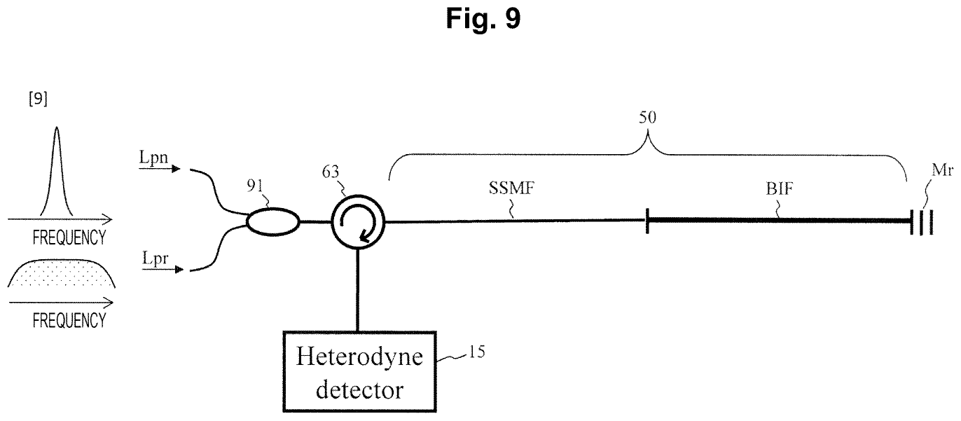

FIG. 9 is a diagram illustrating an experimental system in the present example. An optical fiber 50 to be tested in this experimental system is obtained by connecting a single mode optical fiber SSMF and a low bending-loss optical fiber BIF in series. In the Brillouin gain analysis device 301 in the embodiment, the probe light Lpr enters into one end of the optical fiber 50, and the pump light Lpn enters into the other end. However, in this experimental system, the probe light Lpr which is ASE light and the pump light Lpn which is pulse light having a single frequency enter into one end of the optical fiber 50. In order to form the same state as the Brillouin gain analysis device 301, a mirror Mr is installed at the other end of the optical fiber 50, and the probe light Lpr enters earlier in time than the pump light Lpn. The pump light Lpn entering later interacts with the probe light Lpr reflected by the mirror Mr at the other end, and Brillouin scattering occurs.

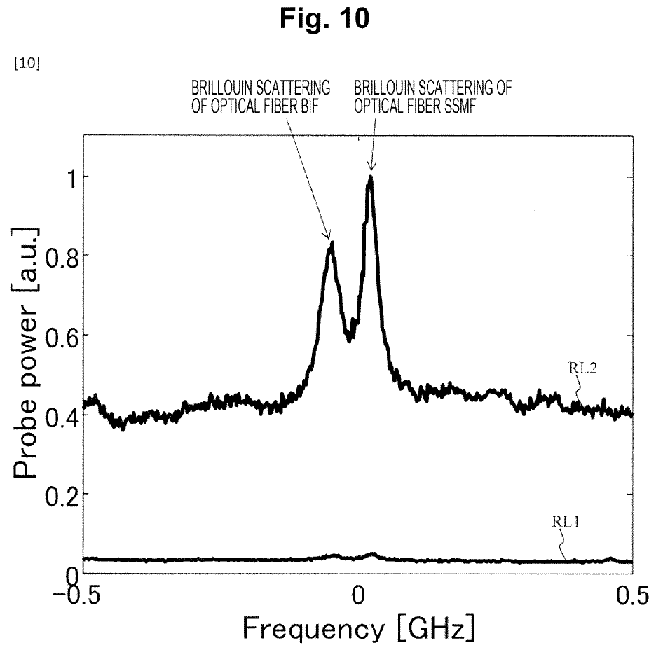

FIG. 10 is a diagram illustrating a result (waveform RL2) obtained in a manner that the detector 15 heterodyne-detects return light including Brillouin scattered light from the optical fiber 50 in the experimental system of FIG. 9.

It is understood that the return light when only the pump light Lpn enters into the optical fiber 50 and the probe light Lpr of the ASE light does not enter into the optical fiber 50 has a waveform RL1, and Brillouin scattering does not occur.

Since two types of optical fibers having different characteristics are used as the optical fiber 50 to be tested, two Brillouin scattering peaks can be observed in the waveform RL2. In FIG. 10, in order to confirm whether Brillouin scattering can be acquired by the ASE light, information of the entire optical fiber 50 is illustrated in one diagram. If the waveform RL2 is converted into a frequency spectrum that is temporally divided, the vibration of the optical fiber 50 can be acquired in a distributed manner. That is, it is understood that, with the present experimental system, probe light is broadened and optical heterodyne detection is used, whereby Brillouin scattered light on an optical fiber can be acquired with one pulsed pump light beam in a distributed manner.

### Effects

In the prior art (Non Patent Literature 1), pulsed ASE light is used as the probe light in order to acquire the BGS of a branched optical fiber. In the present invention, for high-speed measurement with an optical fiber without being branched, the probe light is used as ASE light of continuous light, and an acquired signal is converted into the BGS by using a method such as Fourier transform. With this method, it is possible to acquire the distributed BGS with the pump light that has been pulsed once. The characteristics of the present invention are that, in order to shorten the measurement time necessary for vibration measurement, the continuous light of the ASE light is used as the probe light and the acquired signal is converted into the BGS by a frequency analysis method.

### Definitions

Abbreviations used in the present specification and drawings are as follows.
ASE: Amplified spontaneous emission
PD: Photo Detector
AOM: Acousto optic modulator
EDFA: Erbium doped fiber amplifier
A/D: Analog Digital
BGS: Brillouin Gain Spectrum
BFS: Brillouin Frequency Shift
BPD: Balanced Photo Detector
SSB: Single Side Band

### REFERENCE SIGNS LIST

11 Laser
12 Pulse generator
13 ASE light source
14 Modulator
15 Detector
15a 50:50 coupler
15b Balanced photodiode
21 Change in peak of BGS
22 Any frequency
23 Sweep range
41 Scattered light generation unit
42 Scattered light acquisition unit
50 Optical fiber to be tested
61, 62 Optical amplifier
63 Optical circulator
73 Frequency range of probe light
91 Optical multiplexer
300, 301 Brillouin gain analysis device

1. A Brillouin gain analysis device comprising:
a laser that outputs continuous light having a single frequency;
an amplified spontaneous emission (ASE) light source that generates continuous light that has a frequency component broader than a frequency of the continuous light output by the laser and enters the continuous light into one end of an optical fiber to be measured;
a pulse generator that pulses the continuous light from the laser and enters the pulsed light into another end of the optical fiber;
a modulator that generates local light obtained by shifting the frequency of the continuous light from the laser by any frequency; and
a detector that heterodyne-detects Brillouin scattered light generated by the optical fiber and the local light.

2. The Brillouin gain analysis device according to claim 1, further comprising:
a signal processing unit that performs Fourier transform on a signal heterodyne-detected by the detector to detect a Brillouin gain spectrum (BGS) and acquire a vibration distribution of the optical fiber from a time-series change in a peak of the BGS.

3. A Brillouin gain analysis method comprising:
entering, as probe light, amplified spontaneous emission (ASE) continuous light having a frequency component broader than a frequency of laser light having a single frequency into one end of an optical fiber to be measured;
pulsing the laser light and entering the pulsed light into another end of the optical fiber as pump light;
generating local light by shifting the frequency of the laser light by any frequency; and
heterodyne-detecting Brillouin scattered light generated in the optical fiber and the local light.

4. The Brillouin gain analysis method according to claim 3, further comprising:
performing Fourier transform on the heterodyne-detected signal to detect a Brillouin gain spectrum (BGS); and
acquiring a vibration distribution of the optical fiber from a time-series change in a peak of the BGS.
